(19) United States
(12) Patent Application Publication
(10) Pub. No.: US 2007/0123086 A1
(43) Pub. Date: May 31, 2007

(54) Storage body

(75) Inventors: Takashi Matsunaga, Aichi-ken (JP); Hideyuki Naganawa, Aichi-ken (JP); Nobuo Watanabe, Aichi-ken (JP); Junichiro Kako, Aichi-ken (JP)

Correspondence Address: POSZ LAW GROUP, PLC, 12040 SOUTH LAKES DRIVE, SUITE 101, RESTON, VA, 20191, US

(73) Assignee: TOYODA GOSEI CO., LTD., Aichi-ken (JP)

(21) Appl. No.: 11/604,882

(22) Filed: Nov. 28, 2006

(30) Foreign Application Priority Data
Nov. 29, 2005 (JP) 2005-344242

(51) Int. Cl. H01R 13/62

(52) U.S. Cl. 439/310

(57) ABSTRACT

A storage body with improved decorativeness and an improved degree of freedom in its function and in its design comprises a main body, a cover body, and a locking mechanism. The main body has an opening portion. The cover body is supported by the main body in such a manner that the opening portion can be opened and closed, and has a pair of engaging holes. The locking mechanism engages the cover body with the main body at a position where the opening portion is closed. The locking mechanism is composed of a pair of rods, an urging member, an operating member, and a linking member. The rods, the urging member, and the linking member are provided on a side of the main body, not on the side of the cover body.

### BACKGROUND OF THE INVENTION

1. Field of the Invention

The present invention relates to a storage body such as a glove box provided in an instrument panel of a vehicle of an automobile, etc., for example.

2. Description of the Related Art

Various glove boxes provided in an instrument panel of a vehicle of an automobile, etc. have been known. For example, Japanese Unexamined Patent Publication (KOKAI) No. 2003-13,647 discloses a glove box using a so-called bolt rod to engage a cover body at a close position.

In the glove box disclosed in the publication, a pair of engaging holes is provided in instrument panels facing both side surfaces of the cover body. And, the glove box disclosed in the publication comprises a pair of rods having hook portions which enter into/exit from each engaging hole at their tip ends thereof respectively, an urging member urging each rod in a direction that the each hook portion enters into each engaging hole, an operating member for operating so as to unlock a locking mechanism, and a linking member transmitting an operation force for the operating member to each rod and moving each rod in a direction that each hook portion exits from each engaging hole while resisting an urging force of the urging member.

According to this glove box disclosed in the publication, by operating the operating member, its operating force is transmitted to the rods by way of the linking member. Thus, by exerting the operating force which resists the urging force of the urging member, the rods move such that the hook portions of the rods exit from the engaging holes, and the locking mechanism can be unlocked easily.

However, in this glove box disclosed in the publication, all of the rods, the urging member, and the linking member are stored in the cover body. Thus, the hook portions, which are provided at the tip ends of the rods and enter into/exit from the engaging holes, are exposed in the side surfaces of the cover body. Therefore, when the cover body is opened, it did not have a good appearance since the hook portions can be seen unavoidably. In addition, there arises a problem that the degree of freedom in its function and in its design deteriorates because the thickness of the cover body becomes inevitably thick.

### SUMMARY OF THE INVENTION

The present invention has been developed and completed in view of such circumstances. It is therefore an object of the present invention to provide a storage body in which storing rods, etc. in a cover body is stopped to achieve the improvement in decorativeness and the degree of freedom in function and in design.

A storage body according to the present invention can achieve the aforementioned object, and comprises:

a main body having an opening portion;

a cover body supported by the main body in such a manner that the opening portion can be opened and closed, and having a pair of engaging holes; and

a locking mechanism for engaging the cover body with the main body at a position where the opening portion is closed, wherein:

the locking mechanism is composed of
a pair of rods having hook portions entering into/exiting from each of the engaging holes on their tip ends respectively,
an urging member urging each of the rods in a direction that each of the hook portions enters into each of the engaging holes,
an operating member for operating so as to unlock the locking mechanism, and
a linking member transmitting an operation force for the operating member to each of the rods and moving each of the rods in a direction that each of the hook portions exits from each of the engaging holes while resisting the urging force of the urging member;

each of the rods, the urging member, and the linking member are provided on a side of the main body.

In this storage body, by operating the operating member, its operating force is transmitted to the rods by way of the linking member. Thus, by exerting the operating force which resists the urging force of the urging member onto the operating member, the rods move such that the hook portions of the rods exit from the engaging holes of the cover body. Accordingly, the locking mechanism can be unlocked easily.

And, these rods, urging member, and linking member are provided on the side of the main body, not in the cover body. Thus, the hook portions, which are provided at the tip ends of the rods and enter into/exit from the engaging holes, are not exposed in side surfaces of the cover body when the cover body is opened, and the decorativeness accordingly improves. Moreover, because the cover body does not get thick, the degree of freedom in function and in design improves.

In the storage body according to a preferred embodiment of the present invention, wherein:

the cover body has a pair of leg portions extending to a vicinity of a rear surface of the main body;

each of the engaging holes is provided in each of the leg portions; and

each of the rods is provided in the rear surface of the main body.

In this storage body, the engaging holes are provided in the leg portions of the cover body extending to the vicinity of the rear surface of the main body, and the rods, which have the hook portions entering into/exiting from the engaging holes, are disposed in the rear surface of the main body. Accordingly, the improvement in the decorativeness and the degree of freedom in function and in design can be achieved surely.

Note that, when the rods are disposed in the rear surface of the main body, it is preferred that parts of the linking member and the urging member are also disposed in the rear surface of the main body, and the remaining parts thereof are disposed in side surfaces of the main body.

### BRIEF DESCRIPTION OF THE DRAWINGS

A more complete appreciation of the present invention and many of its advantages will be readily obtained as the same becomes better understood by reference to the following detailed description when considered in connection with the accompanying drawings and detailed specification, all of which forms part of the disclosure.

FIG. 1 is a perspective view for schematically illustrating a storage body according to an example of the present invention with parts of components abbreviated as seen diagonally from above on a side of a rear surface when the cover body is in a closed state.

FIG. 2 is a plan view for schematically illustrating the storage body according to the example of the present invention as seen from above when cover body is in the closed state.

FIG. 3 is a plan view for schematically illustrating the storage body according to the example of the present invention as seen from above right after the locking mechanism is unlocked.

FIG. 4 is a plan view for schematically illustrating the storage body according to the example of the present invention as seen from above when the cover body is in an opened state.

### DETAILED DESCRIPTION OF THE PREFERRED EMBODIMENTS

Having generally described the present invention, a further understanding can be obtained by reference to the specific preferred embodiment which is provided herein for the purpose of illustration only and not intended to limit the scope of the appended claims.

### EXAMPLE

In the example, a storage body according to the present invention is adopted as a glove box provided in an instrument panel of a vehicle body of an automobile, etc.

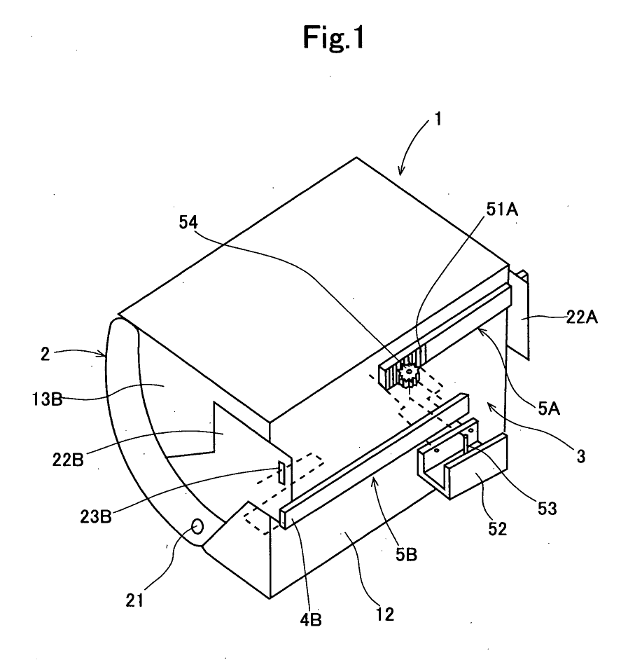

As schematically shown in FIG. 1 to FIG. 4, the storage body according to the example comprises a main body 1 having an opening portion 11, a cover body 2 supported by the main body 1 in such a manner that it can open and close the opening portion 11, and a locking mechanism 3 for engaging the cover body 2 with the main body 1 at a position where the opening portion 11 is closed.

The cover body 2 has a pivotally supporting portion 21 on both sides of a bottom end, and the pivotally supporting portion 21 is pivotally supported in the bottom end adjacent to the opening portion 11 of the main body 1. Thus, the cover body 2 swings about the pivotally supporting portion 21 so as to open and close the opening portion 11.

Also, the cover body 2 has a pair of leg portions 22A, 22B both extending obliquely upward from both sides of a bottom end portion to the vicinity of a rear surface 12 of the main body 1. And, each leg portion 22A, 22B is provided with engaging holes 23A, 23B respectively.

The locking mechanism 3 is composed of a pair of rods 5A, 5B, a first urging member 6, an operating member 7, and a linking member 8. The pair of rods 5A, 5B have hook portions 4A, 4B, which enter into/exit from each of engaging holes 23A, 23B, on their tip ends respectively. The first urging member 6 urges each rod 5A, 5B in the direction that the each hook portion 4A, 4B enters into each engaging hole 23A, 23B respectively. The operating member 7 operates so as to unlock the locking mechanism 3. The linking member 8 transmits an operating force for the operating member 7 to each rod 5A, 5B and moves each rod 5A, 5B in the direction that each hook portion 4A, 4B exits from each engaging hole 23A, 23B while resisting the urging force of the first urging member 6.

At the tip end of the hook portions 4A, 4B, inclined surfaces 41A, 41B, which respectively incline away from side surfaces 13A, 13B of the main body 1 from the opening portion 11 toward the rear surface 12 of the main body 1, are provided.

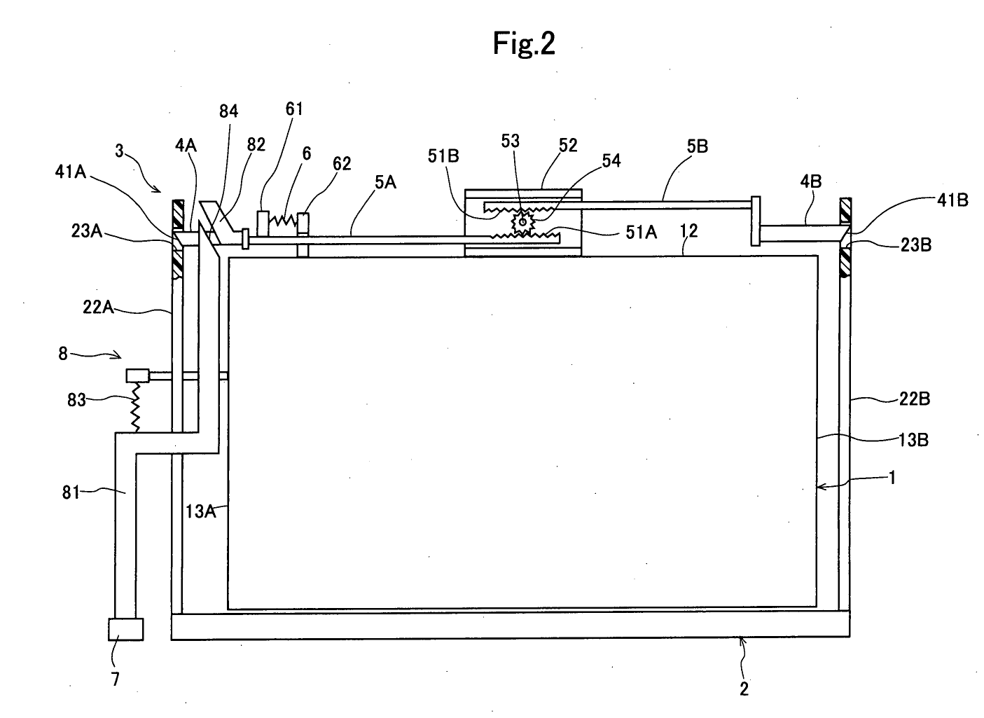

The rods 5A, 5B extend horizontally in an upper portion of the rear surface 12 of the main body 1, and each tip end portion thereof is held slidably in a holding portion 52 which is fastened by bolts, etc. in the rear surface 12 of the main body 1. In addition, rack portions 51A, 51B are provided in tip end facing surfaces wherein the tip ends of the rods 5A, 5B face each other. Also, a shaft portion 53 is build in the center of the top surface of the holding portion 52, and this shaft portion 53 pivotally supports a pinion 54, which meshes with rack portions 51A, 51B, rotatably. Thus, by the mesh of the pinion 54 with the rack portions 51A, 51B, it is arranged such that when one of the rod 5A reciprocates, the other one of the rod 5B interlocks so as also to reciprocate. More specifically, when one of the rod 5A moves from left toward right of FIG. 2, the pinion 54 rotates counterclockwise of FIG. 2, and the other one of the rod 5B interlocks with the rod 5A so as to move from right toward left of FIG. 2 accordingly. On the contrary, when one of the rod 5A moves from right toward left of FIG. 2, the pinion 54 rotates clockwise of FIG. 2, and the other one of the rod 5B interlocks with the rod 5A so as to move from left toward right of FIG. 2 accordingly. That is, both rods 5A, 5B are arranged such that they interlock so as to move in the direction that they come close with each other or they come apart away from each other by meshing the rack portions 51A, 51B thereof with the pinion 54.

The first urging member 6 is composed of a coil spring. One of the opposite ends thereof is fastened to a first projection tab 61 provided in the rod 5A, and the other one of the opposite ends thereof is fastened to a second projection tab 62 provided in the rear surface 12 of the main body 1. Note that, when the cover body 2 is in a closed state as shown in FIG. 2, the first urging member 6 is in a natural state so that no urging force is accumulated in the first urging member 6.

The operating member 7 is provided in the instrument panel, not shown, at the left side position of the main body 1 as shown in FIG. 2.

The linking member 8 is composed of a link rod 81 connected to a rear surface of the operating member 7 and extending along the left side surface 13A of the main body 1 from the opening portion 11 of the main body 1 to the rear surface 12, and a inclined linking portion 82 provided in the vicinity of the hook portion 4A of one of the rod 5A. The link rod 81 is always urged in the direction from the rear surface 12 of the main body 1 toward the opening portion 11 by a second urging member 83 composed of a coil spring. In addition, a sliding inclined surface 84, which face an inclined surface of the inclined linking portion 82, is provided at the tip end of the link rod 81. Accordingly, the inclined surface of this inclined linking portion 82 and the sliding inclined surface 84 slide with each other. Thus, it is arranged such that the movement of the link rod 81 in the depth direction of the main body 1 (the up/down direction of FIG. 2) and the movement of the rod 5A in the width direction of the main body 1 (the left/right direction of FIG. 2) convert with each other.

Note that, each of the rack 51A, 51B and the pinion 54 are also components of the linking member 8 which transmits an operating force for the operating member 7 to each rod 5A, 5B and moves each rod 5A, 5B in the direction that each hook portion 4A, 4B exits from each engaging hole 23A, 23B while resisting the urging force of the first urging member 6.

The storage body according to the present example operates as hereinafter described.

In the closed state of the cover body 2 as shown in FIG. 2, the hook portions 4A, 4B of each rod 5A, 5B respectively enter into the engaging holes 23A, 23B of each leg portion 22A, 22B of the cover body 2 so as to engage with engaging holes 23A, 23B, such that the locking mechanism 3 is locked.

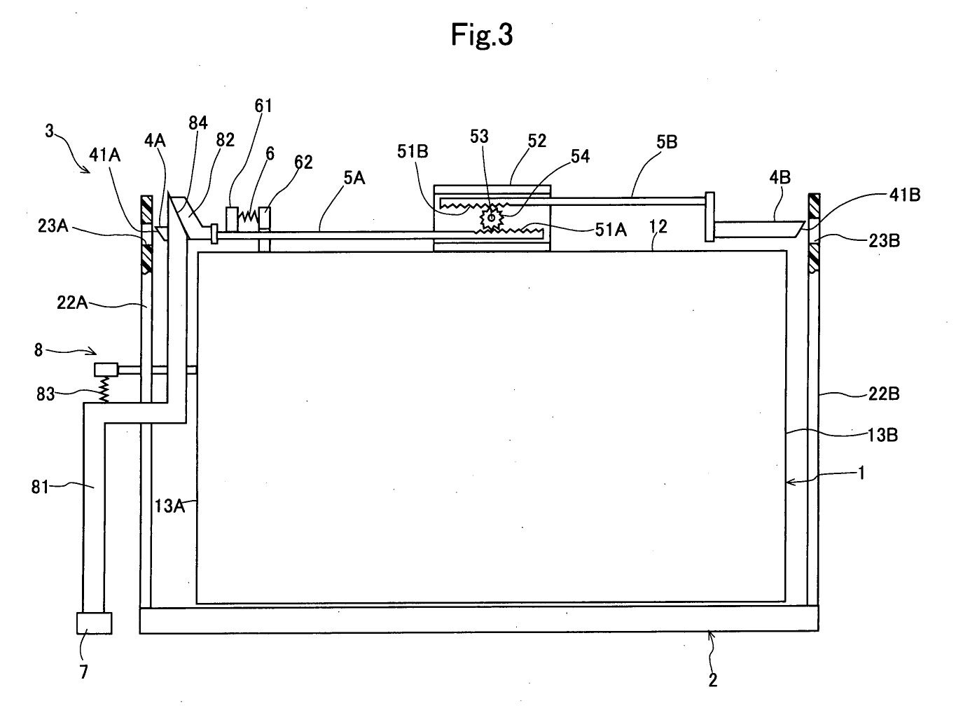

From this closed state, when an operator pushes the operating member 7, the operating force is transmitted to the rods SA, 5B by way of the linking member 8. That is, when the operating member 7 is pushed, the link rod 81 moves to the side of the rear surface 12 of the main body 1 against the urging force of the second urging member 83. Consequently, the sliding inclined surface 84 of the link rod 81 and the inclined surface of the inclined linking portion 82 slide with each other, so that the movement of the link rod 81 to the side of the rear surface 12 is converted with the movement of one of the rod 5A to the right direction of FIG. 2. Thus, the pinion 54 meshes with the rack 51A, 51B, so that the rod 5A and the rod 5B move in the direction that they come close with each other. As a result, the hook portions 4A, 4B of the rods 5A, 5B respectively exit from engaging holes 23A, 23B of each leg portion 22A, 22B of the cover body 2, such that the locking mechanism 3 is unlocked (See FIG. 3).

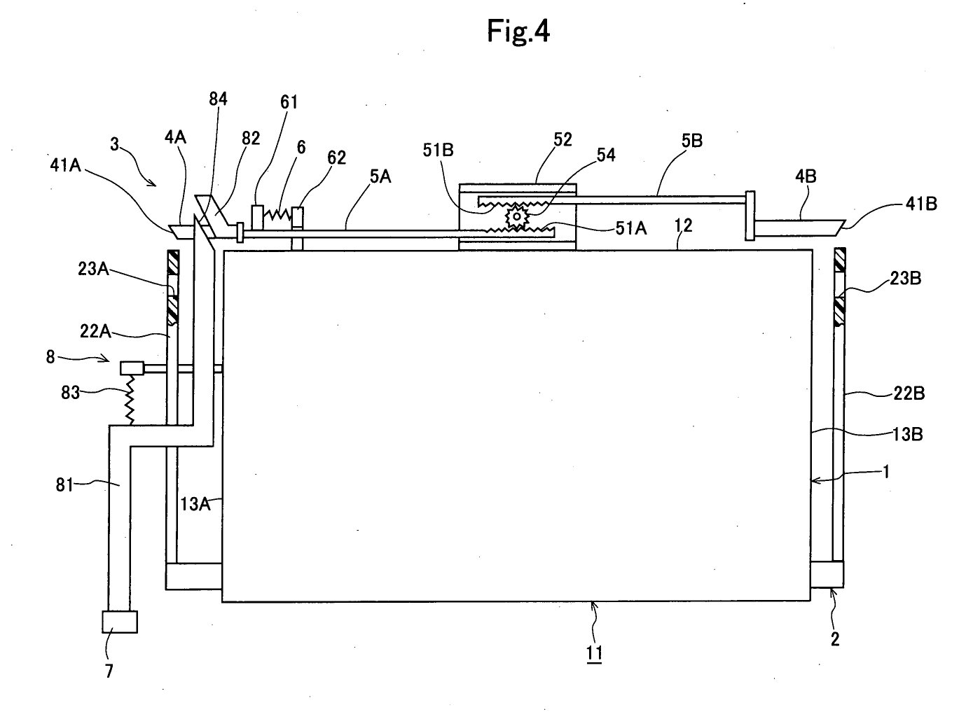

When the locking mechanism 3 is unlocked, the cover body 2 rotates downwardly about the pivotally supporting portion 21 by its own weight, and the opening portion 11 of the main body 1 is released (See FIG. 4). In addition, when the operator stops to push the operating member 7 after the locking mechanism 3 is unlocked, the link rod 81 moves to the side of the opening portion 11 of the main body 1 by the urging force of the second urging member 83. Moreover, in this opened state of the cover body 2, each leg portion 22A, 22B of the cover body 2 also rotates downwardly, and the hook portions 4A, 4B of the rods 5A, 5B do not interfere with each leg portion 22A, 22B of the cover body 2 respectively. Thus, the rod 5A and the rod 5B moves in the direction that they come apart away from each other by way of the mesh of the pinion 54 with the racks 51A, 51B by the urging force of the first urging member 6, and they go back to the original state.

In addition, to return the cover body 2 from the opened state as shown in FIG. 4 back to the closed state as shown in FIG. 2, the operator raises the cover body 2 to let the cover body 2 rotate upwardly about the pivotally supporting portion 21. When the cover body 2 rotates upwardly, each leg portion 22A, 22B also rotates upwardly. Consequently, during the stage in which the cover body 2 returns back to the closed state, tip ends of each leg portion 22A, 22B contact to press the inclined surfaces 41A, 41B of the hook portions 4A, 4B of each rod 5A, 5B. Then, the tip ends of each leg portion 22A, 22B slide on each inclined surface 41A, 41B, so that a pressing force for moving each rod 5A, 5B in the direction that they come close to each other is exerted. As a result, each rod 5A, 5B moves in the direction that they come close to each other against the urging force of the first urging member 6. Then, when the engaging holes 23A, 23B of each leg portion 22A, 22B reach at the positions of the hook portions 4A, 4B of each rod 5A, 5B as the operator holds to continue to let the cover body 2 rotate upwardly, the rods 5A, 5B move in the direction that they come apart from each other by way of the mesh of the pinion 54 with the racks 51A, 51B by the urging force of the first urging member 6. As a result, the hook portions 4A, 4B of each rod 5A, 5B enter into the engaging holes 23A, 23B of each leg portion 22A, 22B, such that the locking mechanism 3 becomes locked.

In addition, in the storage body according to the present example, the rods 5A, 5B, the first urging member 6, and the linking member 8 are provided on the side of the main body 1, not on the side of the cover body 2. Thus, in the opened state of the cover body 2, the hook portions 4A, 4B, which are provided at the tip ends of the rods 5A, 5B and enter into/exit from the engaging holes 23A, 23B, cannot be seen, and the decorativeness improves accordingly. Moreover, because the cover body 2 does not get thick, the degree of freedom in function and in design also improves.

Specifically, in the storage body according to the present example, the rods 5A, 5B, the first urging member 6, the inclined linking portion 82, the racks 51A, 51B and the pinion 53 are all disposed in the rear surface 12 of the main body 1, and the inclined linking portion 82, the racks 51A, 51B and the pinion 53 compose a part of the linking member 8. The link rod 81 and the second urging member 83 composing the rest of the linking member 8 are disposed in the left side surface 13A of the main body 1. Accordingly, the improvement in the decorativeness and the degree of freedom in the function and in the design can be achieved surely.

Note that, in case there is no problem in terms of design when the rods 5A, 5B, the first urging member 6, the linking member 8, and so on are disposed in a top surface or an under surface of the main body 1, these members can be disposed in the top surface or the under surface of the main body 1, not in the rear surface of the main body 1.

Having now fully described the present invention, it will be apparent to one of ordinary skill in the art that many changes and modifications can be made thereto without departing from the spirit or scope of the present invention as set forth herein including the appended claims.

What is claimed is:

1. A storage body, comprising:
a main body having an opening portion;
a cover body supported by said main body in such a manner that said opening portion can be opened and closed, and having a pair of engaging holes; and
a locking mechanism for engaging said cover body with said main body at a position where said opening portion is closed, wherein:
said locking mechanism is composed of
a pair of rods having hook portions entering into/exiting from each of said engaging holes on their tip ends respectively,
an urging member urging each of said rods in a direction that each of said hook portions enters into each of said engaging holes,
an operating member for operating so as to unlock said locking mechanism, and
a linking member transmitting an operation force for said operating member to each of said rods and moving each of said rods in a direction that each of said hook portions exits from each of said engaging holes while resisting the urging force of said urging member;
each of said rods, said urging member, and said linking member are provided on a side of said main body.

2. The storage body set forth in claim 1, wherein:
said cover body has a pair of leg portions extending to a vicinity of a rear surface of said main body;
each of said engaging holes is provided in each of said leg portions; and
each of said rods is provided in the rear surface of said main body.
